(19) United States
(12) Patent Application Publication
(10) Pub. No.: US 2017/0198418 A1
(43) Pub. Date: Jul. 13, 2017

(54) ADHESIVE STRIP FOR WRAPPING MOTOR-VEHICLE CABLES

(71) Applicant: certoplast Technische Klebebaender GmbH, Wuppertal (DE)

(72) Inventors: Peter RAMBUSCH, Wuppertal (DE); Timo Leermann, Wuppertal (DE)

(21) Appl. No.: 15/399,117

(22) Filed: Jan. 5, 2017

(30) Foreign Application Priority Data
Jan. 8, 2016 (DE) 202016100057.2

(51) Int. Cl. D02G 3/26; C09J 201/00; D06N 3/04; C09J 7/02; D03D 15/00; D06N 3/00

(52) U.S. Cl. CPC D02G 3/26; D03D 15/0077; D06N 3/0006; D06N 3/042; C09J 7/0285; C09J 201/00; D06N 2201/02; D06N 2203/041; D10B 2331/04

(57) ABSTRACT

An adhesive strip usable for wrapping motor-vehicle cables has a woven support tape composed of warp yarns and weft yarns made of the same material and having a pair of opposite sides of which at least one has an adhesive coating. A yarn size of the weft yarns is greater than or equal to the yarn size of the respective warp yarns such that the size of the warp yarns measured in the weft direction is less than or equal to the size of the weft yarns measured in the warp direction. The weft yarns are twisted at more than 180 turns per meter of weft yarn. preferably at more than 400 turns per meter of weft yarn.

### FIELD OF THE INVENTION

The present invention relates to an adhesive strip. More particularly this invention concerns such a strip for wrapping motor-vehicle electric cables.

### BACKGROUND OF THE INVENTION

An adhesive strip, for instance for wrapping electrical cables in a motor vehicle, typical has a woven support tape formed of warp yarns and weft yarns of the same material, and having on at least one side an adhesive coating. The yarn size or linear mass density of the weft yarn is greater than or equal to the yarn size of the warp yarn and the size of the warp yarns measured in the weft direction is less than or equal to the yarn size of the weft yarns measured in the warp direction.

Woven fabric adhesive strips and, in particular, wrapping tapes for wrapping motor-vehicle cables must meet a great number of requirements, some of which are contradictory. For example, on the one hand it is important that the adhesive strip or woven fabric adhesive strip in question be mechanically strong and also resistant to gasoline, oil, and heat. Furthermore, such an adhesive strip should be designed so it can be torn by hand in order to facilitate handling when wrapping cables and when making up cable harnesses. Finally, in this connection, a certain friction wear resistance of the woven support tape is required, for example in order to prevent the wrapping from being worn through during use in the motor vehicle. In order to fulfill these different requirements, different approaches are pursued in the state of the art.

Thus, an adhesive strip of this type is known from U.S. Pat. No 6,790,505 in which the warp yarns are fixed in place by the adhesive coating relative to the weft yarns. In this manner, tear strengths in the transverse direction of less than 10 N are observed which hear means that the tape can be torn by hand. Because of the low weaving density in the case of the known woven fabric adhesive strip, however, the danger exists that the weft yarns will be displaced relative to one another, so that the additional fixation by the adhesive coating, as described, is necessary. This in turn has the result that overall the flexibility of the known woven fabric adhesive strip is reduced, so that handling suffers. Furthermore, relatively low friction wear resistance values in accordance with friction wear class A or B according to standard LV312 are observed.

Details regarding this standard, which is common in the automotive sector for determining different friction wear classes, are described in US 2011/0111665, to which reference is explicitly made. In fact, this prior publication concerns itself with a woven fabric adhesive strip that is of a similar type, on the whole. In order to increase the friction wear resistance at this location, the solution is to set the length-related yarn size of the weft yarns or the yarn size of the weft yarns to at least approximately four times the width-related yarn size of the warp yarns or the yarn size of the warp yarns. In this way, sufficient composite strength of the known woven fabric support is supposed to be achieved even without additional fixation of the yarns relative to one another at their intersections by the adhesive coating.

Furthermore, good tearability by hand in the direction of the weft yarns is claimed. At the same time, the yarn size of the weft yarns, which is clearly increased relative to the warp yarns, is supposed to produce a friction wear resistance corresponding to Class C or even greater in accordance with LV312. For this purpose, the number of weft yarns amounts to 20 per centimeter of length, and their size is 470 dtex within the scope of a first variant. Another variant falls back on weft yarns having a size of 570 dtex, and the weft yarns are each formed from three individual threads. The individual threads have a size of 235 dtex for one individual thread and 167 dtex for the remaining two other individual threads, in each instance.

The known woven fabric according to US '665 cited above has a relatively complex structure, and consequently its manufacture is complicated. This is because the warp yarns are made from polyester, whereas the weft yarns consist of polyamide. In this way, a woven fabric support that does not consist of a single material or one composed of warp yarns and weft yarns not made from the same material is implemented. As a result, the woven fabric support causes additional problems with later recycling and leads to increased raw material costs, due to recourse to polyamide.

A different solution according to US 2014/0272367 provides, in the case of a cable-wrapping tape, that the woven fabric consists of a yarn that is once again formed from a polyamide material. In this case, the yarn is formed from individual threads that are twisted together about a center longitudinal axis of the yarn. In this way, the tensile strength of the yarn is fundamentally increased, and the friction wear resistance is also supposed to be increased. In this regard, however, recourse is once again taken to a relatively expensive woven fabric support.

### OBJECTS OF THE INVENTION

It is therefore an object of the present invention to provide an improved adhesive strip, in particular for wrapping motor-vehicle cables.

Another object is the provision of such an improved adhesive strip, in particular for wrapping motor-vehicle cables that overcomes the above-given disadvantages, in particular that is of low manufacturing cost and that at the same time has good friction wear resistance and ability to tear by hand while being easily to recycle.

### SUMMARY OF THE INVENTION

An adhesive strip usable for wrapping motor-vehicle cables. The strip has according to the invention a woven support tape composed of warp yarns and weft yarns made of the same material and having a pair of opposite sides and an adhesive coating on one of the sides. A yarn size of the weft yarns is greater than or equal to the yarn size of the respective warp yarns such that the size of the warp yarns measured in the weft direction is less than or equal to the size of the weft yarns measured in the warp direction. The weft yarns are twisted at more than 180 turns per meter of weft yarn. preferably at more than 400 turns per meter of weft yarn.

In this connection, according to the invention the weft yarns are each composed of threads twisted together about a longitudinal axis at more than 180 turns per meter of weft yarn. In this case, each weft yarn is therefore an individual yarn that is built up from the threads that are twisted together. Alternatively, or also in addition to this, it is conceivable that the weft yarns are each composed of multiple individual threads that are each twisted together about a longitudinal axis and each weft yarn is formed from two or more individual threads. The two or more individual threads are then twisted together at more than 180 turns per meter of weft yarn. In the latter case, the individual threads once again may or may not be composed of threads that in turn are twisted together.

The invention therefore first has recourse to a woven fabric support that is regularly made from warp yarns and weft yarns composed of a single material or of the same material, and consequently can be easily recycled. In fact, the warp yarns and weft yarns are typically formed of polyester filaments. In this way, recycling is simplified and the adhesive strip according to the invention can be made in a particularly cost-advantageous manner. At the same time, a polyester woven fabric meets or the polyester filaments per se meet a major portion of the demands made on wrapping tapes for wrapping motor-vehicle cables.

Thus, polyester filaments not only demonstrate great tensile strength, but furthermore are resistant to chemicals, gasoline, etc. Furthermore, their long-term stability is excellent, and polyester filaments tend not to absorb moisture, or to absorb hardly any moisture. With the design according to the invention according to which the weft yarns within the scope of at least one variant, are designed to be clearly “thicker” as a whole, than the warp yarns, the ability to initiate a tear by hand, which is required for handling, is furthermore enhanced. This also holds true for the case when the warp and weft yarns have the same gauge. This is because in a regular case, the size or linear mass density of the warp and weft yarns typically amounts to at least 40 dtex. Fundamentally, the yarn size can also amount to 80 dtex and more. Preferably, yarn linear mass densities of 100 dtex and more, particularly 167 dtex and more, are employed. In most cases, the adhesive strip according to the invention is characterized in that it is advantageously configured so that it can be torn by hand, specifically taking into consideration a transverse tear force of less than 10 N/cm.

This means that the tear force in the transverse direction, the transverse tear force, of less than 10 N/cm is the basis as a criterion for the ability to tear by hand. For a user, this means that he/she requires tear forces of less than 10 N per centimeter of width in the transverse direction to tear the warp yarns in the direction of the weft yarns.

Because of the different yarn size, within the scope of one variant, of the thinner warp yarns in comparison with the thicker weft yarns, and the additional fact that in general, 40 to 60 warp yarns/cm and 20 to 30 weft yarns/cm are employed, the woven fabric according to the invention or the polyester woven fabric support has a sufficient composite strength of the woven fabric support, specifically without the obligatory adhesive coating contributing or having to contribute to it. As a result, the good ability to tear by hand in the direction of the weft yarns as described above is ensured. The sufficient composite strength of the woven fabric support is simultaneously also supported and guaranteed in that, according to the invention, the weft yarns are twisted together. This means that sufficient composite strength of the woven fabric support and good ability to tear by hand in the direction of the weft yarns, is also observed in the case where the yarn size of the warp yarns and that of the weft yarns is designed to be the same or approximately the same.

The weft yarns formed from the threads that are twisted together, or from the two or more individual threads by twisting, furthermore significantly contribute to great friction wear resistance of the adhesive strip according to the invention. In fact, an increase in the friction wear resistance by approximately 20% to 50% is observed in comparison with an adhesive strip otherwise having the same structure, the same yarn size and the same filament weight, but where the weft yarns are not twisted.

Thus, it is possible that the adhesive strip according to the invention fulfills the requirements at least of friction wear class B, particularly of friction wear class C on a mandrel with a diameter of 5 mm in accordance with the test guideline LV 312. This means that if the adhesive strip according to the invention is adhesively applied to the mandrel in question having a diameter of 5 mm and then the number of strokes required to wear through the adhesive strip is determined using a scraping tool having a needle diameter of 0.45 mm as well as at a weight force of 7 N, the friction wear class C corresponds to 500 to 999 strokes at this location.

As described above, the size of the weft yarn and also of the warp yarn generally amounts to at least 100 dtex. In particular, yarn linear mass densities of 167 dtex and more are observed. Thread thicknesses in this region of 200 dtex, very particularly preferably of 300 dtex and more are very particularly preferred. If, according to one variant, the work is performed so that the yarn size of each weft yarns is dimensioned to be greater than that of the warp yarns, the size of the twisted weft yarn usually amounts to at least 400 dtex, particularly at least 450 dtex. As an upper limit, the invention recommends 550 dtex for the twisted weft yarn in this connection. Very particularly preferably, the size of the twisted weft yarn lies at approximately 500 dtex. In this regard, the related weft yarn can be composed of 20 to 80 filaments or threads, or also from two to at most ten individual filaments. The weft yarn is made by twisting or turning the threads or individual filaments about the longitudinal yarn axis.

Furthermore, the invention recommends that each weft yarn is formed from the threads or the two or more individual filaments that are twisted at more than 450 turns per meter and, in particular, at least 500 turns per meter. Preferably, at this location the work is performed for each weft yarn at 500 to 600 turns per meter of weft yarn when twisting. The weft yarn can have a size of up to 500 dtex. The individual threads alternatively have a size of 100 dtex to 200 dtex, in each instance.

In this way, according to the invention, the weft yarn can be made from relatively thin and conventional individual threads, on the one hand, and on the other hand, the friction wear resistance of the adhesive strip according to the invention is significantly and positively influenced by the weft yarns. This succeeds even if the yarn size of the twisted weft yarn in question amounts to less than 550 dtex and preferably actually lies at approximately 500 dtex. Likewise if the yarn size of the twisted weft yarn amounts to approximately 200 dtex.

This can be attributed to the fact that the twisting increases the tensile strength of the weft yarn on the one hand, and on the other hand the weft yarn remains sufficiently supple for handling. The invention ensures this in that the threads or the individual filaments are twisted together at less than 600 turns per meter of weft yarn. At the same time, the twisted weft yarns are characterized by increased friction wear resistance, and at least friction wear class C is observed for the adhesive strip according to the invention. This can be attributed very significantly to the twisted weft yarns.

During twisting of the threads or the individual filaments to produce the weft yarn, it is possible to work throughout with a right twist or a left twist of the threads or the individual filaments. In both cases, a stable cylindrical cross-section of the respective twisted weft yarn occurs. According to DIN 60 900-4, a distinction is made, depending on the direction of rotation, between S (right twist) and Z (left twist), depending on whether the threads or individual filaments run parallel to the slanted stroke of an S or a Z when allowed to hang down vertically. Fundamentally, of course, it is also possible to work with weft yarns in the woven fabric support that alternately have a right twist and a left twist. In a standard case, however, the weft yarns have a right twist or, alternatively, a left twist throughout.

It has proven advantageous when the width-related yarn size of the warp yarns lies between 2000 dtex/cm and 4000 dtex/cm. For the length-related yarn size of the weft yarns, the invention recommends a range of 8000 dtex/cm to 16,000 dtex/cm. The warp yarns and the weft yarns or the individual filaments that form each twisted weft yarn are formed in a standard case from 20 to 80 filaments or threads. Furthermore, it has proven itself in this connection if the respective individual filaments or threads are each textured, in other words have a curly structure. This specifically applies for the warp yarns just like for the threads or individual filaments for producing the twisted weft yarn and consequently also for the weft yarn as such. By texturing, the elasticity of the respective filaments and their volume is increased.

In the end, a woven fabric adhesive strip and, in particular, a wrapping tape for wrapping motor-vehicle cables is provided that can first of all be made in simple and cost-advantageous manner. Recourse to polyester filaments both in the warp and in the weft makes possible single-material recycling. Furthermore, the adhesive strip according to the invention having a reduced yarn size in comparison with the state of the art and consequently a reduced weight nevertheless has a comparable friction wear resistance. In spite of this, the required ability to initiate tearing by hand in the transverse direction continues to be guaranteed, so that use succeeds in simple manner. These can be seen as being the significant advantages.

### BRIEF DESCRIPTION OF THE DRAWING

The above and other objects, features, and advantages will become more readily apparent from the following description, reference being made to the accompanying drawing in which:

FIG. 1 is a perspective top view of the adhesive strip according to the invention;

FIGS. 1A and 1B are large-scale views of the details shown at IA and IB in FIG. 1; and

FIG. 2 is a section through the adhesive strip according to FIG. 1.

### SPECIFIC DESCRIPTION OF THE INVENTION

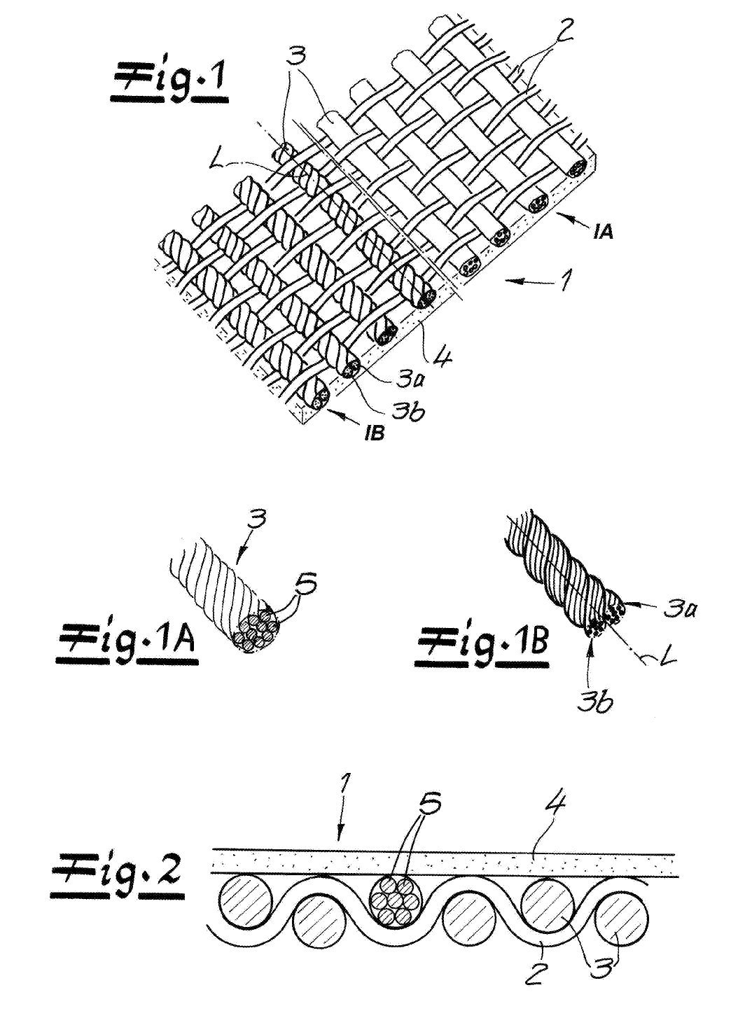

As seen in FIG. 1, a woven fabric adhesive strip is shown that serves as a wrapping or cable wrapping tape in this embodiment. The adhesive strip or wrapping tape is used for wrapping motor-vehicle cables. For this purpose, the adhesive strip has a woven support tape 1 composed of warp yarns 2 and weft yarns 3 of the same type and material. In this embodiment, both the warp yarns 2 and the weft yarns 3 are made of polyester filaments. Furthermore, an adhesive coating 4 is provided on at least one side.

As seen in FIG. 2, the adhesive coating 4 is here present on a back face of the woven fabric support 1. The adhesive coating 4 has been applied to the woven fabric support 1 as an adhesive on an acrylate basis by coating as a hot-melt adhesive. Of course, this applies only as an example and is not restrictive.

FIG. 1 shows that the yarn size of the weft yarns 3 is greater than the yarn size of the respective warp yarns 2. Furthermore, the width-related yarn size of the warp yarns 2 is designed to be less than the length-related yarn size of the weft yarns 3. This holds true, in any case, for this embodiment shown. Fundamentally, the weft yarns 3 and the warp yarns 2 can, however, be configured the same, in each instance, in terms of their yarn size. However, this is not shown. In this case, the yarn size of the warp yarns measured in the weft direction also corresponds to the yarn size of the weft yarns measured in the warp direction. In both cases, 46 warp yarns 2 per centimeter width of the woven fabric support 1 are used according to this embodiment. The number of weft yarns 3 per centimeter length of the woven fabric support 1 amounts to 27/cm. This is shown only in part in the figure.

The yarn size or filament gauge of the respective warp yarns 2 amounts to 48 dtex. In connection with the thread count indicated above of 46/cm, this results in the width-related yarn size of the warp yarns 2 at 46 cm·48 dtex=2208 dtex/cm.

In contrast, the weft yarns 3 have a yarn size or thread gauge of approximately 500 dtex. The weft yarns 3, in this embodiment and according to the invention, are twisted weft yarns 3 that in the present case are twisted at more than 400 turns per meter of each weft yarn 3. In fact, two variants are pursued in the present case. Thus, FIG. 1B shows weft yarns 3 that are composed of two individual threads 3a, 3b twisted together about a longitudinal axis L. This is shown in FIG. 1B. In this embodiment, the individual threads 3a, 3b each have a yarn size of 250 dtex. In general, the individual threads each have a yarn size from 100 dtex to 300 dtex.

In FIG. 1A, a variant is shown in which each weft yarn 3 is composed of threads 5 twisted together about a longitudinal axis L. The weft yarn 3 is an single-strand yarn. The threads 5 of this individual yarn are once again twisted together at more than 400 turns per meter of weft yarn 3. At this point, a total of 20 to 80 threads 5 per weft yarn 3 can be used. This is shown simplified and schematically in FIG. 1. In both variants of FIG. 1, the yarn size of the weft yarn amounts to about 500 dtex or less.

Furthermore, the design is such that the two individual threads 3a, 3b, in FIG. 1B, have the same and corresponding yarn size of 250 dtex in the example shown. Fundamentally, of course, it is also possible to work with individual threads 3a, 3b having a different yarn size when twisting and producing the weft yarn 3. Something comparable applies to the case that weft yarns 3 having a different number of threads 5 corresponding to the variant in FIG. 1A, are used. When twisted together, the threads 5, just like the individual threads 3a, 3b wind about the respective longitudinal axis L at more than 400 turns per meter of weft yarn 3.

This means that the twisted weft yarn 3 in FIG. 1B is composed of the individual threads 3a, 3b, that have been twisted together around the longitudinal axis L at more than 400 turns per meter of length of the twisted weft yarn 3. In the variant shown in the FIG. 1A, the twisted weft yarn 3 is composed of the threads 5 that in turn have been twisted together about the related longitudinal axis L at more than 400 turns. In this manner, the yarn size of the twisted weft yarn 3, in both cases, amounts to less than 550 dtex and at least 450 dtex, approximately 500 dtex in this embodiment.

Instead of the two individual threads 3a, 3b for producing the twisted weft yarn 3 according to the variant in FIG. 1B, at most ten individual threads 3a, 3b can be used for production, but this is not shown. Furthermore, work is generally carried out at 500 to 600 turns of the threads 5 or the individual threads 3a, 3b per meter of the twisted weft yarn 3. The weft yarns 3 have a right twist or left twist of the threads 5 or of the individual threads 3a, 3b throughout, as already described above.

Because the weft yarns 3, in the present case, each have a thread gauge or yarn size of approximately 500 dtex and, in this embodiment, a total of 27 weft yarns/cm are used, the yarn size of the weft yarns measured in the warp direction amounts to 27 cm·500 dtex=13500 dtex/cm, in total.

From this, what is called the titer quotient can be determined, in other words the ratio of the size of the weft yarns 3 measured in the warp direction to the size of the warp yarns 2 measured in the weft direction. This ratio amounts, in the present case, to approximately 6.1, namely 13500:2208. In general, the invention works with titer quotients of 2 to 8. This is because the yarn size of the warp yarns 2 measured in the weft direction lies between 2000 to 4000 dtex/cm, in total. In contrast, the yarn size of the weft yarns 3 in the warp direction lies in the range from 8000 dtex/cm to 16,000 dtex/cm.

The individual yarns 2, 3, in other words the warp yarns 2 and/or the weft yarns 3, can be textured. This consequently also holds true for the threads 5 or for the individual threads 3a, 3b. Furthermore, the adhesive strip or woven fabric adhesive strip shown is configured so that it can be torn by hand. This means that to start a tear in the transverse direction, i.e. in the direction of the weft yarns 3, a transverse tear force of less than 10 N/cm of width of the woven fabric support 1 is required.

We claim:

1. An adhesive strip usable for wrapping motor-vehicle cables, the strip comprising:
a woven support tape composed of warp yarns and weft yarns made of the same material and having a pair of opposite sides, a yarn size of the weft yarns being greater than or equal to the yarn size of the respective warp yarns such that the size of the warp yarns measured in the weft direction is less than or equal to the size of the weft yarns measured in the warp direction, the weft yarns being twisted at more than 180 turns per meter of weft yarn; and
an adhesive coating on one of the sides.

2. The adhesive strip defined in claim 1, wherein the weft yarns are each composed of threads twisted with one another about a longitudinal yarn axis, the threads being twisted with one another at more than 400 turns per meter of weft yarn.

3. The adhesive strip defined in claim 1, wherein the weft yarns are each composed of individual threads twisted with one another about a longitudinal yarn axis, the weft yarns being formed from two or more individual threads twisted with one another at more than 400 turns per meter of weft yarn.

4. The adhesive strip defined in claim 1, wherein the yarn size of the twisted weft yarn and the yarn size of the warp yarn is at least 40 dtex.

5. The adhesive strip defined in claim 4, wherein the yarn size of the twisted weft yarn and that of the warp yarn amount to less than 550 dtex.

6. The adhesive strip defined in claim 1, wherein each weft yarn is formed from 2 to 10 threads or 20 to 80 threads.

7. The adhesive strip defined in claim 1, wherein each weft yarn is formed from two or more individual threads that are twisted with one another at more than 450 turns per meter of weft yarn.

8. The adhesive strip defined in claim 1, wherein the yarn size of the warp yarns in the weft direction lies between 2000 dtex/cm and 4000 dtex/cm.

9. The adhesive strip defined in claim 1, wherein the yarn size of the weft yarns in the warp direction is between 8000 dtex/cm and 16000 dtex/cm.

10. The adhesive strip defined in claim 1, wherein the woven fabric support is made of polyester.

11. The adhesive strip defined in claim 11, wherein both the warp yarns and the weft yarns are of polyester.

12. The adhesive strip defined in claims 1 to 10, wherein the warp yarns and the weft yarns or the individual threads that form the weft yarns are each formed from 20 to 80 filaments.

13. The adhesive strip defined in claim 1, wherein the individual threads of the twisted weft yarns each have a yarn size of 100 dtex to 300 dtex.

14. The adhesive strip defined in claim 1, wherein the weft yarns are each formed from two or more individual threads having the same yarn size.

15. The adhesive strip defined in claim 14, wherein the threads are textured.

16. The adhesive strip defined in claim 1, wherein the number of warp yarns is between 40 and 60 per centimeter.

17. The adhesive strip defined in claim 1, wherein the number of weft yarns is between 20 and 30 per centimeter.

18. The adhesive strip defined in claim 1, wherein the warp and weft yarns impart to the adhesive strip such a tear resistance that it can be torn by hand with a transverse tear force of less than 10 N/cm.

19. The adhesive strip defined in claim 1, wherein the adhesive strip meets the requirements of friction-wear class C on a mandrel having a diameter of 5 mm in accordance with LV312.

20. The adhesive strip defined in claim 1, wherein the titer quotient, as the ratio of the yarn size of the weft yarns in the warp direction and the yarn size of the warp yarns in the weft direction lies between 2 and 8.
